(19) United States
(12) Patent Application Publication
(10) Pub. No.: US 2024/0161647 A1
(43) Pub. Date: May 16, 2024

(54) SYSTEMS AND METHODS FOR FACILITATING ENGAGEMENT AND LEARNING IN A LEARNING ENVIRONMENT

(71) Applicant: TOPHATMONOCLE CORP., Toronto (CA)

(72) Inventors: Andrew Joseph CORWAY, Toronto (CA); Arel Nestor ROCHE, Toronto (CA); Gregory Philip ROGERS, Toronto (CA)

(21) Appl. No.: 18/388,590

(22) Filed: Nov. 10, 2023

Related U.S. Application Data
(60) Provisional application No. 63/425,917, filed on Nov. 16, 2022.

(51) Int. Cl. G09B 5/14; G06Q 50/20

(52) U.S. Cl. CPC G09B 5/14; G06Q 50/20

(57) ABSTRACT

There is provided a method for conducting a lecture. The method including transmitting to a plurality of learner devices signals for providing a graphical user interface that presents one or more requests to the leaners to provide structured feedback at a corresponding plurality of first content locations predefined to be interspersed among a plurality of ordered content segments and one or more requests to the learners to provide unstructured feedback, receiving the structured and unstructured feedback from at least one of the learners, upon analyzing the structured and unstructured feedback, estimating engagement metrics each measuring a degree of engagement of the learners at a corresponding time points during the lecture, and transmitting to a lecturer device, data for generating a visual representation of the engagement metrics, including a graph of the degree of engagement over the plurality of time points and visually mapped to the content segments.

### CROSS-REFERENCES TO RELATED APPLICATIONS

This application claims all benefit including priority to U.S. Provisional Patent Application No. 63/425,917 filed on Nov. 16, 2022, entitled “SYSTEMS AND METHODS FOR FACILITATING ENGAGEMENT AND LEARNING IN A LEARNING ENVIRONMENT”, the contents of which are hereby incorporated by reference.

### FIELD

This disclosure generally relates to the field of educational technology and, in particular, to facilitating learner engagement.

### BACKGROUND

Lecturers can sometimes struggle with ascertaining learner engagement and comprehension. Learners may be apprehensive to reveal their own ignorance in front of their classmates. Lecturers may struggle to get responses from the class even when the instructor asks questions directly to the class. Further, lecturers may struggle to get to know the learners and, in particular, those who do not participate. Lecturers may fail to appreciate when some learners are struggling with the content. A lecturer, facing these challenges, may not understand whether the content is being taken up by the students. The lecturer may struggle to appropriately pace their lectures.

Owing to these challenges, improvements in the field are desirable.

### SUMMARY

In the face of the challenges described above, systems and methods to help aid a lecturer in receiving and compiling feedback from learners can help the lecturer more effectively deliver their educational content. Feedback may take the form of low-barrier participation, for example, providing feedback at pre-defined points in the content or having the option, at any point, to select a response. Further this feedback can be provided anonymously. The lecturer in receipt of this feedback may be able to more easily assess class comprehension and may be able to tailor the lecture accordingly.

Other advantages of some embodiments include the ability to provide the lecturer with a stream of real-time feedback on the content, compile and assess the feedback to provide the lecturer with the most relevant insights, track feedback and engagement based on location within the content (e.g., feedback delivered during which content segment) to better suggest the areas in the content that may require better explanations, and to track feedback from particular learners to flag struggling learners to the lecturer and potentially suggest separate educational interventions over and above the general content.

In accordance with an aspect, there is provided a computer-implemented method for conducting a lecture. The method including transmitting to a plurality of learner devices, each operated by a corresponding learner of a plurality of leaners, signals for providing a graphical user interface that presents one or more requests to the leaners to provide structured feedback at a corresponding plurality of first content locations predefined to be interspersed among a plurality of ordered content segments, each segment including a portion of learning content for the lecture and one or more requests to the learners to provide unstructured feedback at a plurality of second content locations that are not predefined, receiving the structured feedback from at least one of the learners, receiving the unstructured feedback from at least one of the learners, upon analyzing the structured feedback and the unstructured feedback, estimating a plurality of engagement metrics each measuring a degree of engagement of the learners at a corresponding one of a plurality of time points during the lecture, and transmitting to a lecturer device, data for generating a visual representation of the engagement metrics, the visual representation including a graph of the degree of engagement over the plurality of time points and visually mapped to the content segments.

In accordance with a further aspect, the computer-implemented method further includes transmitting to the learner devices signals to cause a visual indicator of the unstructured feedback to be displayed by way of the graphical user interface, in response to receiving the unstructured feedback.

In accordance with a further aspect, the visual indicator is displayed in real-time during the lecture.

In accordance with a further aspect, the unstructured feedback includes an emoji selected from a plurality of emojis.

In accordance with a further aspect, the plurality of emojis including emojis corresponding to a plurality of sentiments expressible by the learners.

In accordance with a further aspect, the plurality of emojis include an emoji indicating a request to increase the pace of the lecture, and an emoji indicating a request to decrease the pace of the lecture.

In accordance with a further aspect, the request for structured feedback includes a question with multiple answers, each answer selectable by the learners.

In accordance with a further aspect, the method further includes receiving, in association with each of the unstructured feedback and the structured feedback, an identifier of the particular learner of the plurality of leaners providing the feedback.

In accordance with a further aspect, the method further includes upon processing the unstructured feedback and the structured feedback and the identifiers of the learners providing the feedback, generating an insight regarding a potential intervention for a particular learner of the plurality of leaners.

In accordance with a further aspect, the insight is generated by applying a machine learning model.

In accordance with a further aspect, the method further includes providing the potential intervention to the particular learner as an intervention, receiving feedback on the intervention from the particular learner, and updating the machine learning model based in part on the feedback from the particular learner.

In accordance with a further aspect, the insight includes data reflecting a profile of the given learner.

In accordance with a further aspect, the insight includes an identifier of recommended learning content suitable for the potential intervention.

In accordance with a further aspect, the method further includes transmitting to the plurality of learner devices signals for causing a chatbox to be presented by way of the graphical user interface, the chatbox allowing the learners to exchange electronic messages during the lecture.

In accordance with a further aspect, the estimating a plurality of engagement metrics includes processing the electronic messages.

In accordance with a further aspect, the method further includes receiving signals reflective of computer input activity of at least one of the learners.

In accordance with a further aspect, the estimating a plurality of engagement metrics includes processing the activity of the computer input the at least one of the learners.

In accordance with a further aspect, the degree of engagement includes a quality of engagement.

In accordance with a further aspect, the method further includes transmitting to at least one of the plurality of learner devices signals for providing a graphical user interface that presents the plurality of ordered content segments to a corresponding at least one learner.

In accordance with a further aspect, the method further includes transmitting to a presentation device signals for providing a graphical user interface that presents the plurality of ordered content segments to one or more of the learners of a plurality of leaners.

In accordance with a further aspect, the lecture includes at least one of a virtual lecture, an in-person lecture, and a hybrid lecture.

In accordance with an aspect there is provided a computer-implemented system for conducting a lecture. The system includes at least one processor, memory in communication with said at least one processor, and software code stored in said memory. When executed at said at least one processor, the code causes the system to transmit to a plurality of learner devices, each operated by a corresponding learner of a plurality of leaners, signals for providing a graphical user interface that presents one or more requests to the leaners to provide structured feedback at a corresponding plurality of first content locations predefined to be interspersed among a plurality of ordered content segments, each segment including a portion of learning content for the lecture and one or more requests to the learners to provide unstructured feedback at a plurality of second content locations that are not predefined, receive the structured feedback from at least one of the learners, receive the unstructured feedback from at least one of the learners, upon analyzing the structured feedback and the unstructured feedback, estimate a plurality of engagement metrics each measuring a degree of engagement of the learners at a corresponding one of a plurality of time points during the lecture, and transmit to a lecturer device, data for generating a visual representation of the engagement metrics, the visual representation including a graph of the degree of engagement over the plurality of time points and visually mapped to the content segments.

Many further features and combinations thereof concerning embodiments described herein will appear to those skilled in the art following a reading of the instant disclosure.

### DESCRIPTION OF THE FIGURES

In the figures,

FIG. 1 illustrates an infrastructure diagram of a virtual learning environment, according to some embodiments.

FIG. 2 illustrates a computing device for carrying out processes to facilitate learning and engagement, according to some embodiments.

FIG. 3 illustrates an example lecturer view prior to initiating a lecture, according to some embodiments.

FIG. 4A illustrates an example lecturer view while the lecture is being presented, according to some embodiments.

FIG. 4B illustrates an example lecturer action bar available while the lecture in FIG. 4A is being presented, according to some embodiments.

FIG. 5 illustrates an example lecturer view with the lecturer notes and chatbox open while the lecture is being presented, according to some embodiments.

FIG. 6A illustrates a window enabling the lecturer to initiate a student check-in, according to some embodiments.

FIG. 6B illustrates a window showing progress of an ongoing student check-in, according to some embodiments.

FIG. 6C illustrates a window showing results of an ongoing student check-in, according to some embodiments.

FIG. 7A illustrates an example learner view while the lecture is being presented, according to some embodiments.

FIG. 7B illustrates an example learner action bar available while the lecture in FIG. 7A is being presented, according to some embodiments.

FIG. 7C illustrates an example learner quick reaction bar available while the lecture in FIG. 7A is being presented, according to some embodiments.

FIG. 8 illustrates an example learner view with the notes and chatbox open while the lecture is being presented, according to some embodiments.

FIG. 9 illustrates an example lecturer view displaying a notification based on unstructured feedback, according to some embodiments.

FIG. 10A illustrates an example pre-lesson reflection for learners, according to some embodiments.

FIG. 10B illustrates an example post-lesson reflection for learners, according to some embodiments.

FIG. 11A illustrates an example post-lecture report, according to some embodiments.

FIG. 11B illustrates an example post-lecture report with content block specific information displayed, according to some embodiments.

FIG. 12 illustrates an example lecturer view after a lecture, according to some embodiments.

FIG. 13 illustrates a process diagram for a method of facilitating learning and engagement in a learning environment, according to some embodiments.

FIG. 14 illustrates a schematic diagram of a computing device which may be used to implement the virtual lecture device, according to some embodiments.

### DETAILED DESCRIPTION

Systems, methods, and devices described herein may be configured to solicit feedback (structured and unstructured) from learners, analyze the feedback, and provide the lecturer with engagement metrics to aid them in the delivery of their content. These systems, methods, and devices may further be configured to generate content-segment-specific or learner-specific insights and may make suggestions based thereon.

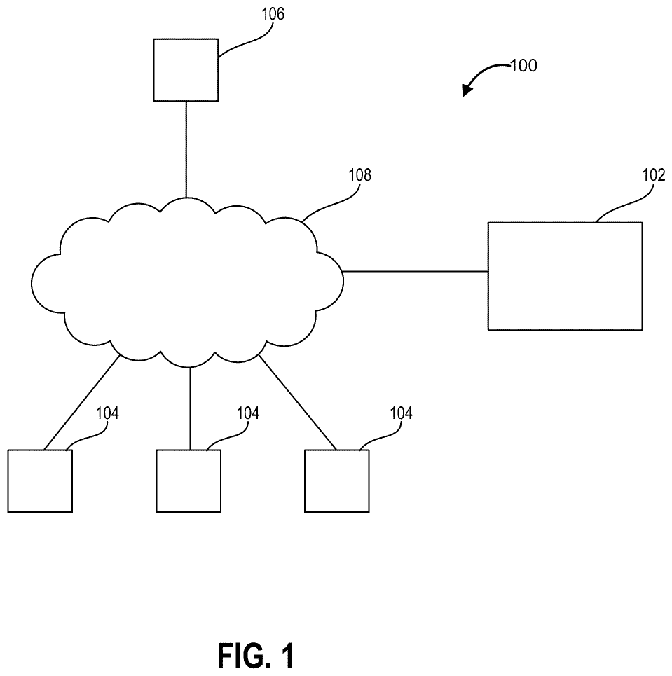

FIG. 1 illustrates an infrastructure diagram of a virtual learning environment 100, according to some embodiments.

Virtual learning environment 100 comprises a virtual lecture server 102, a plurality of learner device 104, a lecturer device 106, and a communications network 108 through which the components are able to communicate. The virtual lecture server 102 can be a remote server. The learner devices 104 and the lecturer device 106 can be the learners' and lecturer's personal computing devices running, for example, specific applications. The learner devices 104 and the lecturer device 106 may be configured to present the respective user (i.e., learner or lecturer) with different content and options depending on their role. The learner devices 104 may further be configured to present content specific to that learner (e.g., their grades, past notes, etc.). The communications network 108 can enable virtual lecture server 102, learner device 104, and lecturer device 106, to exchange data with each other and is capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The virtual lecture server 102 can be configured to conduct a virtual lecture between the lecturer and learners. The virtual lecture server 102 may be configured to instruct the lecturer device 106 to, for example, present options to the lecturer to initiate the lecture, advance through content segments of the lecture, provide information on feedback (structured or unstructured), and present the lecturer with a lecturer view of the content segments (e.g., the current content segment and all other content segments). The virtual lecture server 102 may be configured to instruct the learner devices 104 to present the learners with options to, for example, provide feedback (structured and unstructured), and present the learners with a learner view of the content segments (e.g., the current content segments and options to review previously presented content segments). The virtual lecture server 102 may be configured to receive information from the learner devices (e.g., structured and unstructured feedback), compile and analyze the information, and instruct the lecturer device 106 to prompt the lecturer with engagement insights or provide the lecturer with a report.

The learner device 104 may be configured to receive input from the learners (e.g., students, pupils, attendees, etc.) to, for example, receive structured and/or unstructured feedback from the learners, receive computer input activity data, and record notes. The learner device 104 may also optionally be configured to present the current content segment to the learner. The learner device 104 may also enable the learner to review other content segments, such as those that have already been presented in the lecture.

The lecturer device 106 may be configured to receive input from the lecturer to, for example, initiate a lecture, move through content segments, initiate a student check-in, or request other feedback. The lecturer device 106 may be configured to present the lecturer with the current content segment. The lecturer device 106 may also enable the lecturer to review other content segments. The lecturer device 106 may also be configured to present the lecturer with data regarding learner engagement such as the results of structured feedback embedded within the content or the current/past unstructured feedback given by learners. The lecturer device 106 may further be configured to provide notifications to the lecturer (e.g. an alert or warning such as when a pre-defined proportion of learners indicate confusion within a pre-defined period of time or on the same content segment).

Though the environment 100 is described as a virtual learning environment, the skilled person would appreciate that these teachings could be adapted and applied to hybrid and in-class learning environments. For example, in a hybrid setting, the learner devices for remote learners may present the lecture content to the remote learners while learner devices for in-class learners may only present the in-class learners with the requests for structured and/or unstructured feedback and the lecture content is presented on an in-class display for all in-class learners. It is also conceived that there may be no difference between in-class learner devices and remote learner devices (i.e., the in-class learners can see the lecture content on their learner device).

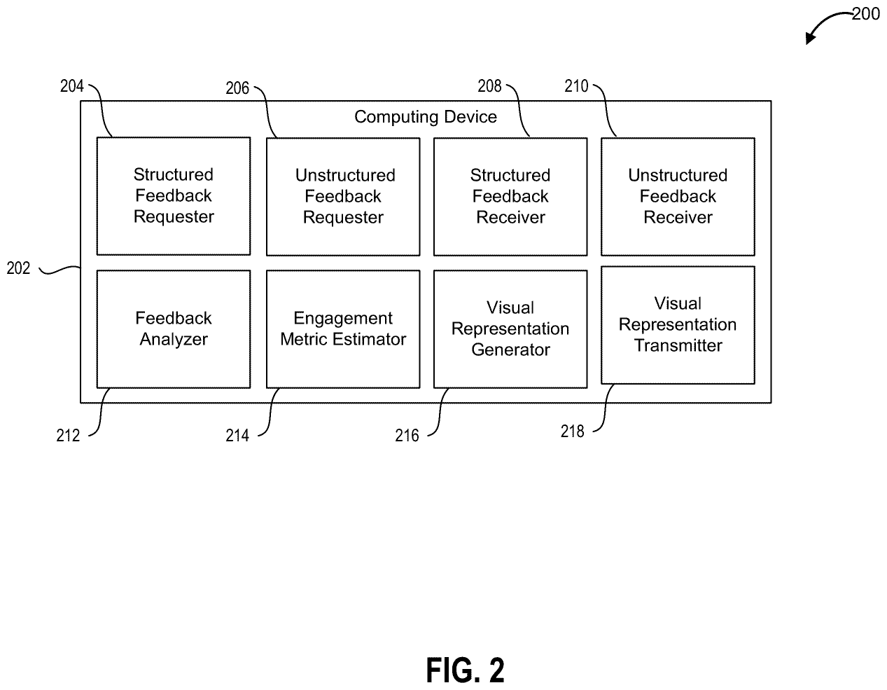

FIG. 2 illustrates a system 200 comprising a computing device 202 for carrying out processes to facilitate learning and engagement, according to some embodiments. The computing device 202 can be configured to carry out the tasks associated with virtual lecture server 102 of FIG. 1.

The system 200 comprises a computing device 202. It is to be understood that computing device 202 could comprise a single computing device or a plurality of computing devices in communication (directly or indirectly) with one another (e.g., distributed computing or the “cloud”). The computing device 202 comprises a structured feedback requester 204, an unstructured feedback requester 206, structured feedback receiver 208, unstructured feedback receiver 210, feedback analyzer 212, engagement metric estimator 214, visual representation generator 216, and visual representation transmitter 218. In some embodiments, some functions may be carried out by other devices such as the lecturer device 104 or the learner devices 106.

The lecture can be created beforehand by a lecturer (or another user or by other algorithmic or machine learning processes). The lecturer (or other user) can preload and organize the content that will make up the learning content. This content can be divided into segments (e.g., slides, videos, requests, or other blocks of content) that will be presented in an ordered fashion to the learners. Within the learning content the lecturer (or other user) can intersperse requests for structured feedback from the learners. The structured feedback can comprise requests for feedback at predefined locations within the content. The lecturer (or other user) can also configure the learning content to include requests for unstructured feedback from the learners. The unstructured feedback can comprise requests for feedback not tied to particular locations within the content (e.g., on an ongoing basis).

The structured feedback requester 204 can transmit requests for structured feedback to learner devices at appropriate predefined locations in the content. The structured feedback requests can be associated with specific locations in the content. When the lecturer reaches this location in the content, then the structured feedback requester can request feedback from the learners. The feedback request can take the form of a specific questions regarding the content, general questions to ascertain a level of understanding, or other feedback formats. The feedback requested can take the form of selecting one or more options from a selection of options (e.g., expressions, emojis, etc.), selecting a level of agreement with a statement, placing a marker on a spectrum or image, providing text comments, or other form of feedback.

The unstructured feedback requester 206 can transmit requests for unstructured feedback to learner devices. The unstructured feedback requests may be made of the learners throughout the learning session in that learners can provide one or more feedback messages at any time. The unstructured feedback requester 206 can generate requests with the same properties as described above for the structured feedback requester 204. Unstructured feedback may also take the form of passive actions by the learners (e.g., notes taken by the learners, computer activity, active program window, etc.).

The structured feedback receiver 208 can receive the structured feedback provided by the learners at the predefined locations in the content. The structured feedback may be received anonymously or it may be associated with a learner identifier. Where a learner identifier is used, the feedback may nonetheless be provided to the lecturer in an anonymous fashion or in a manner where the lecturer can access the user identity after the lecture (but it is not easily accessible during lecture). The feedback may also make the user visible to the lecturer (e.g., on the lecturer device), but hide their identity from other learners in the lecture (e.g., on the learner devices or a presentation device). This anonymity or temporary anonymity may encourage learners to participate without fear of judgement from peers.

The unstructured feedback receiver 210 can receive the unstructured feedback provided by the learners. The unstructured feedback may be received anonymously or it may be associated with a learner identifier as described above. The unstructured feedback receiver 210 may also associate the feedback with a time-code or content segment during which it was received. This positioning data may be used to track engagement over time or content segment.

The feedback analyzer 212 can analyze the feedback received from the learners. For example the feedback analyzer may compile data relevant to the lecture (e.g., total number of learners in the class, user identifiers associated with the feedback, etc.). The feedback analyzer 212 may review the feedback to ascertain whether there are any common themes among the feedback. For example, where feedback is provided in the form of comments, the feedback analyzer 212 may be able to parse the comments to determine topics (i.e., what subject or content segment the comment regards) and sentiment (i.e., whether the learners understood the segment or were confused by it). The feedback analyzer 212 may provide these to engagement metric estimator 214 and/or may save these analyses into a data store associated with the content (e.g., the content segments) and/or the learners (e.g., in a learner profile).

The engagement metric estimator 214 can estimate a plurality of engagement metrics. For example, the engagement metric estimator 214 can analyze engagement metrics that indicate a degree of engagement of the learners. These can include, for example, the proportion of learners that participated in providing feedback (e.g., structured feedback) or the sentiments of the learners on various topics (e.g., indicating that a high proportion of learners provided the “confused” unstructured feedback during a particular content segment; i.e., comprehension). The engagement metric estimator 214 may be able to assess the engagement of particular learners as compared to their typical level of engagement or comprehension (e.g., learner A is participating 50% less than usual or learner B has indicated they are confused numerous times during the lecture when they normally understand) or compared to their peers. It may also use accuracy of answers provided by learners to assess engagement. The engagement metric estimator 214 may also compile learner specific insights to provide insights to the lecturer (e.g., engagement is down, but those who are engaging are engaging a lot). The engagement metric estimator 214 can also associate the feedback received with the location in the content and provide insights based thereon.

The visual representation generator 216 can generate a visual representation of the engagement metrics. The visual representation generator 216 may be configured to generate visual representations based on what is most salient in the engagement metrics (e.g., prompting the lecturer with a warning when a high volume of learners report confusion). The visual representation generator 216 may update passive and ongoing visual representations (e.g., adding emojis to a running reaction stream). Visual representation generator 216 may associate the feedback and/or engagement metrics with specific locations in the content and present them in association with these locations. Visual representation generator 216 may be configured to pull information from various data stores to generate, for example, a learner profile for the lecturer's review. The learner profile may be based on current or recent engagement metrics associated with that learner as well as other information from that learner (e.g., basic biographical information, recent evaluation results for that learner, etc.).

The visual representation transmitter 218 can transmit the visual representation to the lecturer device for display to the lecturer. The visual representation transmitter 218 may be configured to push these visual representations at any time during a virtual lecture (e.g., prompts that a high number of learners are confused) or it may push them at the end of the lecture (e.g., in a post-lecture report). Visual representation transmitter 218 may also be configured to push some aspects of the visual representations to the learner devices as well (e.g., all learners and the lecturer may be able to see a running reactions stream of emojis). Making aspects of the feedback visible to learners may encourage participation by showing learners that participation by their peers is occurring.

Each of the structured feedback requester 204, the unstructured feedback requester 206, the structured feedback receiver 208, the unstructured feedback receiver 210, the feedback analyzer 212, the engagement metric estimator 214, the visual representation generator 216, and the visual representation transmitter 218 may be implemented using a combination of software and hardware. In the case of software implementation, conventional programming languages such as Java, J#, C, C++, C#, R, Perl, Visual Basic, Ruby, Scala, etc., may be used, and the implementation may include one or more executable programs, scripts, routines, statically/dynamically linkable libraries, or servlets.

In accordance with an aspect there is provided a computer-implemented system 200 for conducting a lecture. The system 200 includes at least one processor, memory in communication with said at least one processor, and software code stored in said memory. When executed at said at least one processor causes the system to transmit to a plurality of learner devices, each operated by a corresponding learner of a plurality of leaners, signals for providing a graphical user interface that presents one or more requests to the leaners to provide structured feedback at a corresponding plurality of first content locations predefined to be interspersed among a plurality of ordered content segments, each segment including a portion of learning content for the lecture using a structured feedback requester 204 and one or more requests to the learners to provide unstructured feedback at a plurality of second content locations that are not predefined using an unstructured feedback requester 206, receive the structured feedback from at least one of the learners using the structured feedback receiver 208, receive the unstructured feedback from at least one of the learners using the unstructured feedback receiver 210, upon analyzing the structured feedback and the unstructured feedback using feedback analyzer 212, estimate a plurality of engagement metrics each measuring a degree of engagement of the learners at a corresponding one of a plurality of time points during the lecture using engagement metric estimator 214, and transmit to a lecturer device, data for generating a visual representation of the engagement metrics from visual representation generator 216 using visual representation transmitter 218, the visual representation including a graph of the degree of engagement over the plurality of time points and visually mapped to the content segments.

In accordance with a further aspect, the computer-implemented system 200 further configured to transmit to the learner devices signals to cause a visual indicator of the unstructured feedback to be displayed by way of the graphical user interface, in response to receiving the unstructured feedback.

In accordance with a further aspect, the visual indicator is displayed in real-time during the lecture.

In accordance with a further aspect, the unstructured feedback includes an emoji selected from a plurality of emojis.

In accordance with a further aspect, the plurality of emojis including emojis corresponding to a plurality of sentiments expressible by the learners.

In accordance with a further aspect, the plurality of emojis include an emoji indicating a request to increase the pace of the lecture, and an emoji indicating a request to decrease the pace of the lecture.

In accordance with a further aspect, the request for structured feedback includes a question with multiple answers, each answer selectable by the learners.

In accordance with a further aspect, the system 200 is further configured to receive, in association with each of the unstructured feedback and the structured feedback, an identifier of the particular learner of the plurality of leaners providing the feedback.

In accordance with a further aspect, the system 200 is further configured to, upon processing the unstructured feedback and the structured feedback and the identifiers of the learners providing the feedback, generate an insight regarding a potential intervention for a particular learner of the plurality of leaners.

In accordance with a further aspect, the insight is generated by applying a machine learning model.

In accordance with a further aspect, the system 200 is further configured to provide the potential intervention to the particular learner as an intervention, receive feedback on the intervention from the particular learner, and update the machine learning model based in part on the feedback from the particular learner.

In accordance with a further aspect, the insight includes data reflecting a profile of the given learner.

In accordance with a further aspect, the insight includes an identifier of recommended learning content suitable for the potential intervention.

In accordance with a further aspect, the system 200 is further configured to transmit to the plurality of learner devices signals for causing a chatbox to be presented by way of the graphical user interface, the chatbox allowing the learners to exchange electronic messages during the lecture.

In accordance with a further aspect, estimating a plurality of engagement metrics using engagement metric estimator 214 includes processing the electronic messages.

In accordance with a further aspect, the system 200 is further configured to receive signals reflective of computer input activity of at least one of the learners.

In accordance with a further aspect, estimating a plurality of engagement metrics using engagement metric estimator 214 includes processing the activity of the computer input the at least one of the learners.

In accordance with a further aspect, the degree of engagement includes a quality of engagement.

In accordance with a further aspect, the system 200 is further configured to transmit to at least one of the plurality of learner devices signals for providing a graphical user interface that presents the plurality of ordered content segments to a corresponding at least one learner.

In accordance with a further aspect, the system 200 is further configured to transmit to a presentation device signals for providing a graphical user interface that presents the plurality of ordered content segments to one or more of the learners of a plurality of leaners.

In accordance with a further aspect, the lecture includes at least one of a virtual lecture, an in-person lecture, and a hybrid lecture.

### System Operation

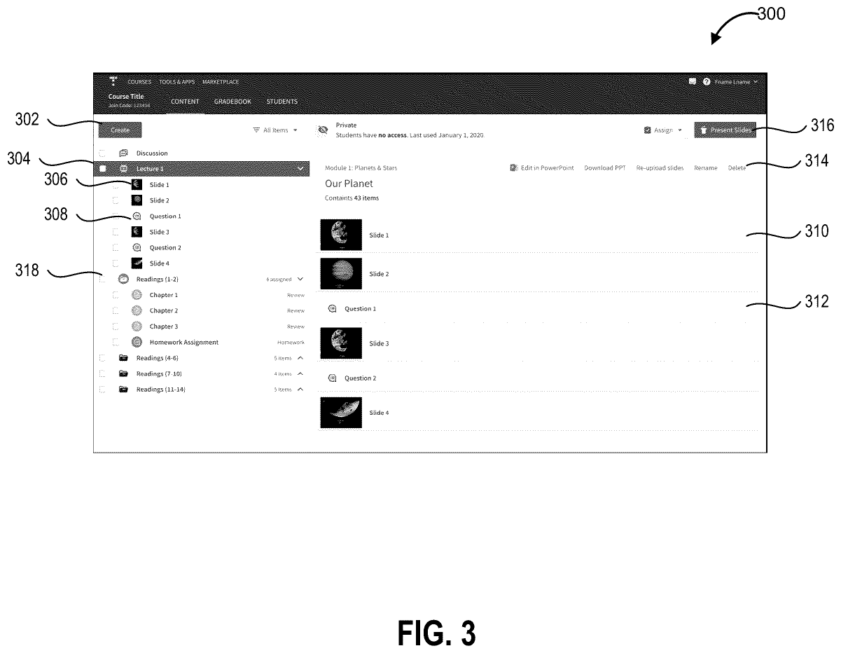

FIG. 3 illustrates an example lecturer view 300 prior to initiating a lecture, according to some embodiments.

The lecturer view 300 includes a create option 302, a lecture drop down 304, a slide select 306, a question select 308, a slide 310, a question 312, edit options 314, a present slides option 316, and other dropdowns 318. The lecturer can use lecturer view 300 to create, review, revise, and initiate the presentation of lecture content. The lecturer can also create, review, revise, and initiate other forms of assignment (e.g., readings, homework, assignments, etc.).

Create option 302 can be selected by the lecturer to begin the creation of lecture content (or other assignment types). The create option 302 can ask the lecturer what type of content they would like to create and initialize a drop down menu for same.

The lecture drop down 304 can allow the lecturer to review, edit, and present previously created lectures (specifically Lecture 1 in this case). The lecturer can press lecture drop down 304 to open a drop down menu including all content segments (e.g., slide select 306 and question select 308) to easily navigate through the content segments contained in the lecture. The lecture drop down 304 may also enable the lecturer to add or edit a type of unstructured feedback available to learners throughout the presentation of the lecture.

The slide select 306 can enable the lecturer to easily open or navigate to the associated slide from the navigation window along the left. Additional functionality can also be accessed by manipulating slide select 306, such as deleting the slide associated with slide select 306 or moving it to other locations within the content. Other slide selects (not indicated) are associated with other slides in the lecture content.

The question select 308 can perform similar functionality as the slide select 306.

The slide 310 can enable the lecturer to open the content in the slide (e.g., the content segment) to review or edit it. Pressing the slide open 310 may redirect the lecturer into another screen that enable them to more precisely edit the slide and provide them with additional options of doing same. Slide 310 may also provide engagement metrics based on past presentations.

The question 312 can enable the lecturer to open the content in the question (e.g., the structured feedback request) to review or edit it. Pressing the question open 312 may redirect the lecturer into another screen that enable them to more precisely edit the slide and provide them with additional options of doing same. Question 312 may also provide engagement metrics (e.g., accuracy of learner answers) based on past presentations.

The edit options 314 provide the lecturer with options of editing the lecture content. For example, the lecturer can open the lecture content in conventional slide processing software. The lecturer can also download the lecture content as a conventional slide deck. The lecturer can re-upload slides to update the lecture content. The lecture can also rename or delete the slides.

The present slides option 316 enables the lecturer to initiate the presentation of the lecture content to the learners. In pressing this button, the virtual lecture device can transmit signals to the learner devices to provide them with the content (should the content be presented by the lecture devices) and the requests for feedback.

Other dropdowns 318 may be associated with other functionality to facilitate engagement and learning in a virtual environment (e.g., readings and discussions)

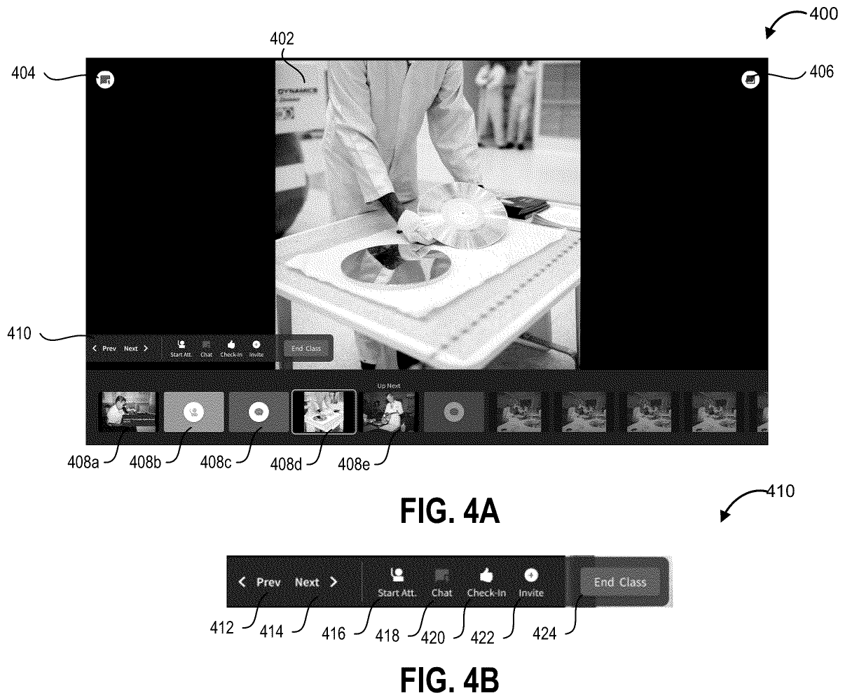

FIG. 4A illustrates an example lecturer view 400 while the lecture is being presented, according to some embodiments.

The lecturer view 400 shows the current content segment in the main window 402, chat open 404, notes open 406, content segments 408 (inclusive of 408a-408e), and lecturer action bar 410. The lecturer device may be configured to show lecturer view 400 during the presentation of the content. This can enable the lecturer to easily navigate within the lecture content.

The main window 402 will show the current content segment. This will allow the lecturer to see the content currently being displayed to the learners. The content displayed in the main window 402 will depend on the content segment. For example, it could be an image or text (or combination thereof) or an audio and/or video file that plays during the content segment. During a request for structured feedback, a question may be displayed in main window 402.

The chat open 404 and notes open 406 can be used to open the chatbox and lecturer notes tabs respectively.

The content segments 408 are illustrated along the bottom of the lecturer view 400. The content segments can include for example a title segment 408a, an attendance segment 408b, a question segment 408c, a current segment 408d, and a future segment 408e. The lecturer can have access to all content segments 408 from the lecturer view 400 including segments that have not yet been presented (namely future segments 408e). The attendance segment 408b may initiate a structured feedback request to take the attendance of the learners present in the class. Such an attendance segment may also ask that the learners conduct a pre-lesson reflection (described below).

The lecturer action bar 410 includes a number of actions available to the lecturer while the lecture content is being provided.

FIG. 4B illustrates an example lecturer action bar 410 available while the lecture in FIG. 4A is being presented, according to some embodiments.

The lecturer action bar 410 includes options to move to a previous content segment 412, move to the next content segment 414, start attendance 416, open the chat 418, conduct a student check-in 420, invite someone 422, and end class 424.

The move to a previous content segment 412 and move to the next content segment 414 can allow the lecturer to quickly navigate between the content segments that are being displayed to the learners.

The start attendance 416 can easily request that the learners indicate who is present. This can be used as a form of structured feedback or to recalibrate the total number of learners present.

The open the chat 418 can allow the lecturer to open the chatbox to see what learners have been saying. Messages can be open (everyone can see) or private (only the lecturer can see) or some combination thereof.

The conduct a student check-in 420 can enable the lecturer to conduct a student check-in (namely a form of structured feedback that the lecturer slots into the content while the lecture is occurring; described below). This can allow the lecturer to take a heat check of the engagement and/or comprehension of the class for content segments recently presented. The lecturer can customize the check-in to ask substantive questions of the learners or request their general feeling about their understanding.

The invite someone 422 can be used to invite someone into the lecture. For example, it can be used to specifically invite a particular learner into the virtual lecture. It can also be used to invite those who are not learners into the lecture (e.g., guest speakers).

The end class 424 can allow the lecturer to end the lecture. This can further trigger the system to compile and analyze all the feedback received during the lecture and generate an end of lecture report on the level of learner engagement and/or comprehension during the lecture.

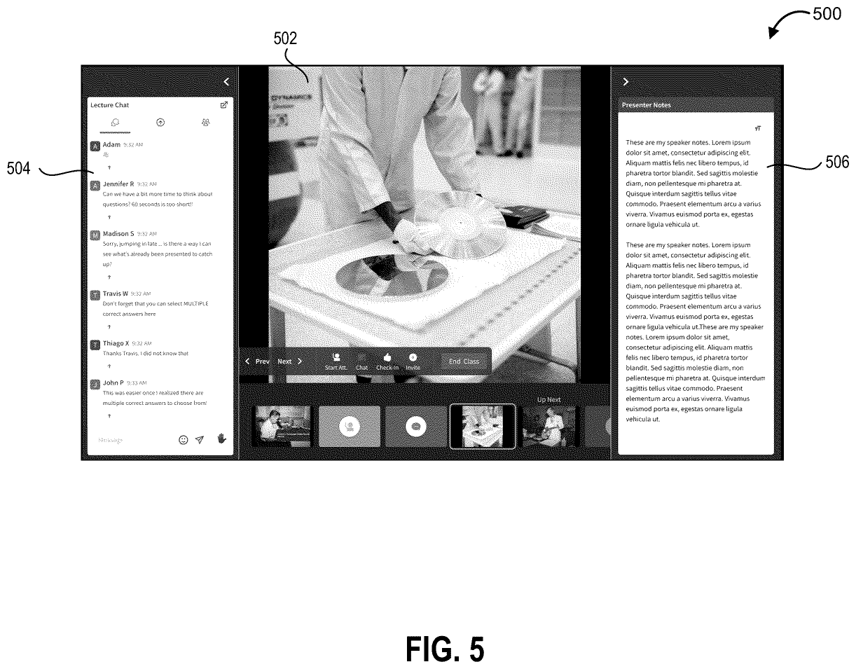

FIG. 5 illustrates an example lecturer view 500 with the lecturer notes 506 and chatbox 504 open while the lecture is being presented, according to some embodiments.

The lecturer view 500 shows the view when the chatbox 504 and lecturer notes 506 are opened. The main window 502 is still visible.

The chatbox 504 can be used by the lecturer to see comments provided by learners. The lecturer can respond to these comments in real-time during the lecture or within the chat. The comments received from learners can be open (namely, everyone else in the lecture can see them) or they can be direct (namely, only the lecturer can see them). In some embodiments, the learners are able to select which style (open or direct) they will communicate with. In some embodiments, the learners can provide comments anonymously. In some embodiments, comments may be anonymous when displayed to other users (i.e., in the learner view), but the lecturer can still see the identity of the commenter (i.e., in lecturer view).

The lecturer notes 506 can provide a place where the lecturer can pre-load notes prior to the presentation of the content. This can be done to ensure the lecturer mentions all points that they need to cover while discussing that content segment. The lecturer notes may also be updated during the lecture (e.g., so the lecturer can make a note of questions posed by the learners for which they do not have an answer, but will check for one offline). The lecturer notes can be visible only to the lecturer in lecturer view or they can be displayed to the learners in their display as well.

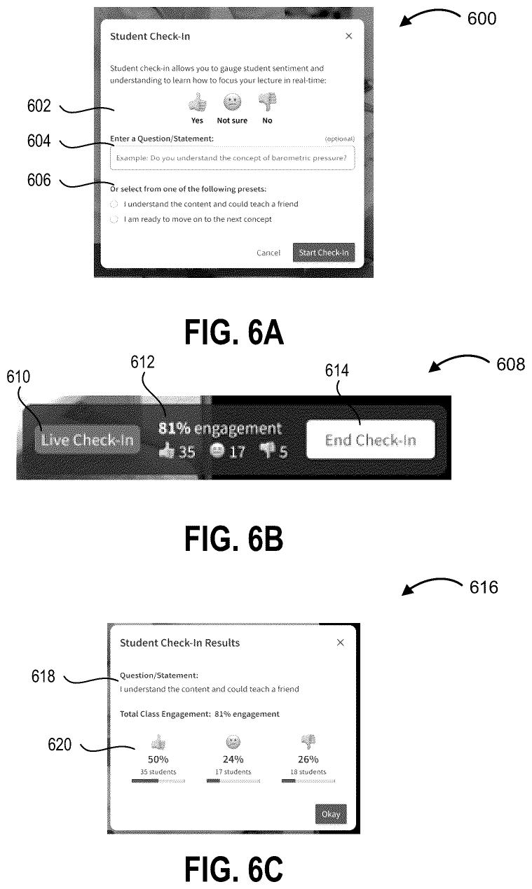

FIG. 6A illustrates a window 600 enabling the lecturer to initiate a student check-in, according to some embodiments.

As mentioned above, the lecturer may have the option of requesting structured feedback from the learners mid-lecture. To do so they may need to select an option (e.g., student check-in 420 in FIG. 4B) which will open window 600. Window 600 can provide the lecturer with options in generating the structured feedback questions such as allowing the lecturer to select the feedback format 602 from the learners, to enter a question or expression 604, or to select a pre-set 606. Other possible customizations not shown include selecting the time that the check-in will last.

The student check-in allows the lecturer to generate and request structured feedback in a more free-form way based on the reception of the lecture. With a particularly engaged class, it may be beneficial for the lecturer to include fewer structured feedback requests in the content and instead use the check-ins based on the level of engagement from the learners during the lecture. For example, where the learners are actively using the chatbox and/or providing unstructured feedback indicating that they understand, it may break the pacing of the lecture to stop to specifically ask the learners whether they understand the subject matter. In these scenarios the lecturer can rely on the unstructured feedback, but will still have the option of soliciting structured feedback should the learners be uncharacteristically quiet (e.g., little chat, little unstructured feedback provided) without having to predict where that might happen.

Select the feedback format 602 can enable the lecturer to select how the learners will provide their structured feedback. Here a default of three emojis is shown corresponding to “Yes”, “Not sure”, and “No”. In some embodiments the lecturer may be able to exclude some options (e.g., eliminating the “Not sure” option). In some embodiments, the lecturer may be able to change the style or response (e.g., ask for text feedback, additional emojis, or placing a mark along a spectrum). Generally the types of feedback format possible in a student check-in can generally correspond to the types of feedback configurable in a question made in advance of the lecture.

The question or expression 604 can be used to enter a question or expression. The format of this box may changed based on the type of feedback requested by the lecturer. For example, where the lecturer wants to ask learners to place a mark along a spectrum between two opposing statements, the question or expression 604 may ask the lecturer to enter two separate statements.

The select a pre-set 606 can provide the lecturer with pre-set (or default or recently used) options so that they may quickly initiate the student check-in. These pre-sets may be useful where the lecturer is just trying to ascertain whether the learners comprehend the material in the current content segment (e.g., “I understand the content and could teach a friend” or “I am ready to move on to the next concept” are both general purpose expressions that could be used for most content).

FIG. 6B illustrates a window 608 showing progress of an ongoing student check-in, according to some embodiments.

The progress window 608 could be superimposed somewhere on the main display of the lecturer view. It could display a status 610, results 612, and an end 614. This progress window 608 could be used by the lecturer to engage the learners in providing feedback (e.g., by saying, for example, “let's get to 90% engagement”).

The status 610 could indicate whether the check-in is live, has concluded, is in error, or some other status indicator.

The results 612 could display the results. These results could include, for example, engagement metrics (e.g., “84% engagement”) and raw results (e.g., the total number of people who selected each option). The results 612 may provide other forms of metrics (e.g., percentage of learners who do not understand the concept or percent that did not select the right answer).

The end 614 could be used by the lecturer to conclude the student check-in. In embodiments where the check-in is preconfigured to elapse a certain time, the countdown may appear here. In some embodiments with a countdown, the lecturer may be able to prematurely conclude the student check-in where they believe a sufficient number of learners have participated.

A variant of the progress window 608 may be displayed on learner devices for the learners to see. In such variants, they may be able to see the status 610, the results 612, and any countdown. In such variants, the learner may first be presented with their options (rather than the results) and they will need to select an option before the results 612 will be displayed for them.

FIG. 6C illustrates a window 616 showing results of an ongoing student check-in, according to some embodiments.

The results window 616 could display when the student check-in is completed. The results window 616 could show the question or expression posed 618 and the results 620. Additional analysis could be conducted on the feedback prior to generating the results. For example, the system may be able to ascertain whether there has been an improvement in learner engagement and/or comprehension.

A similar results window 616 could also be displayed to the learners themselves. Some variations may be that the learner results windows 616 include less granular data (e.g., approximating results to provide additional de-identification of information).

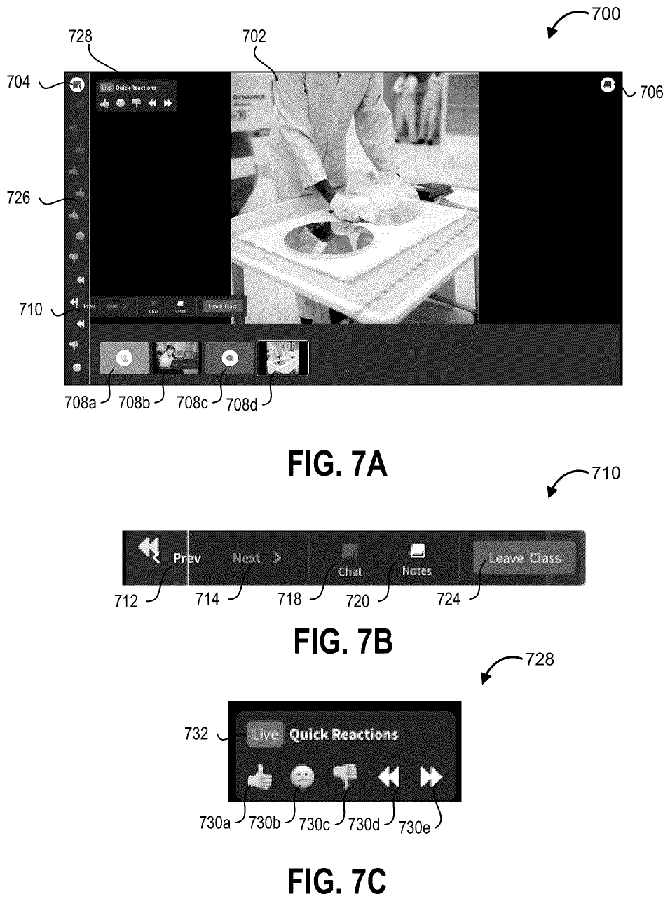

FIG. 7A illustrates an example learner view 700 while the lecture is being presented, according to some embodiments.

Learner view 700 is similar to that of the lecturer view 400 (in FIG. 4A), but with some reduced and/or altered functionality. The learner view 700 shows the current content segment in the main window 702, chat open 704, notes open 706, content segments 708 (inclusive of 708a-708d), and learner action bar 710. It also includes the reaction stream 726 and a quick reaction bar 728.

The main window 702 can show the current content segment. This can allow the learner to see the content currently being displayed. The content displayed in the main window 702 will depend on the content segment

The chat open 704 and notes open 706 can be used to open the chatbox and learner notes tabs respectively.

The content segments 708 are illustrated along the bottom of the learner view 700. The content segments can include for example attendance segment 708a, a title segment 708b, a question segment 708c, and a current segment 708d. Unlike the lecturer, learners may only have access to the content segments which have already been presented (to prevent them from skipping ahead).

The learner action bar 710 includes a number of actions available to the learner while the lecture content is being provided.

The reaction stream 726 shows the reactions of the learner and others during the lecture. This reaction can be provided by the quick reaction bar 728 which is an ongoing unstructured feedback request. The learner may be able to, at any point, select a quick reaction using quick reaction bar 728. Their quick reaction will populate in the quick reaction stream 726. The quick reaction stream 726 can illustrate the reactions from all other learners. This can be done anonymously, anonymously for other learners but identified to the lecturer, or in an identified fashion. This can provide a relatively low-barrier way for some learners to participate. The reactions may animate after they are selected. The reactions may be slowly pushed off the screen as new reactions are selected by other learners (e.g., slowly being pushed off the top of the display as new reactions populate the bottom). The reactions can slowly fade out over time (e.g., so that reactions to segments from a few minutes ago are clearly much less relevant as time moves forward).

FIG. 7B illustrates an example learner action bar 710 available while the lecture in FIG. 7A is being presented, according to some embodiments.

The learner action bar 710 is similar to the lecturer action bar 410 (in FIG. 4B). It includes options to move to a previous content segment 712, move to the next content segment 714, open the chat 718, open notes 720, and end class 724.

The move to a previous content segment 712 and move to the next content segment 714 can allow the learner to quickly navigate between the content segments. The learner may only be able to navigate between content segments which have already been presented.

The open the chat 718 can allow the learner to open the chatbox to see what other learners have been saying.

The open notes 718 can allow the learner to open the notes window to see their personal notes on this content segment.

The leave class 424 can allow the learner to leave the lecture. This can track that they are no longer in the class and therefore no longer counted for engagement metrics. It can also save the content segment at which they had to leave so that they can easily pick up where they left off when they return. It may also trigger a post-lesson reflection.

FIG. 7C illustrates an example learner quick reaction bar 728 available while the lecture in FIG. 7A is being presented, according to some embodiments.

The quick reaction bar 728 can be available to learners for the entire or the majority of the lecture. It can be used by the learners to provide the lecturer with unstructured feedback relevant to the content segments currently or recently displayed. The quick reaction bar 728 can include a plurality of reactions 730 (inclusive of 730a-730e) which each correspond to a possible reaction. For example, a thumbs-up 730a can indicate comprehension or acceptance of the content segment, unsure 730b can indicate uncertainty or ambivalence about the content segment, thumbs-down 730c can indicate confusion or disapproval of the content segment, rewind 730d can indicate that the learner would like the lecturer to slow down, and fast-forward 730e can indicate that the learner would like the lecturer to speed up.

The quick reaction bar 728 can also include a status indicator 732 to let the learner know whether or not they can provide quick reactions.

When selected, these reactions can populate into the reaction stream 726 which may be visible to all other learners or just to the lecturer. The reactions may also be tracked by the system as a form of unstructured feedback and are used to develop the engagement metrics. In some embodiments, the location in the content at which the quick reaction was selected will be tracked and incorporated into engagement metrics for that particular content segments. In some embodiments, the quick reactions can also be associated with a user profile to track whether that learner seems to be confused a lot during lectures (which may indicate that additional learning interventions may be required).

Learners may have unlimited opportunities to provide quick reactions, they may be limited to particular content segments (or ranges thereof), or they may have a cool down (to ensure learners don't spam the reaction stream 726).

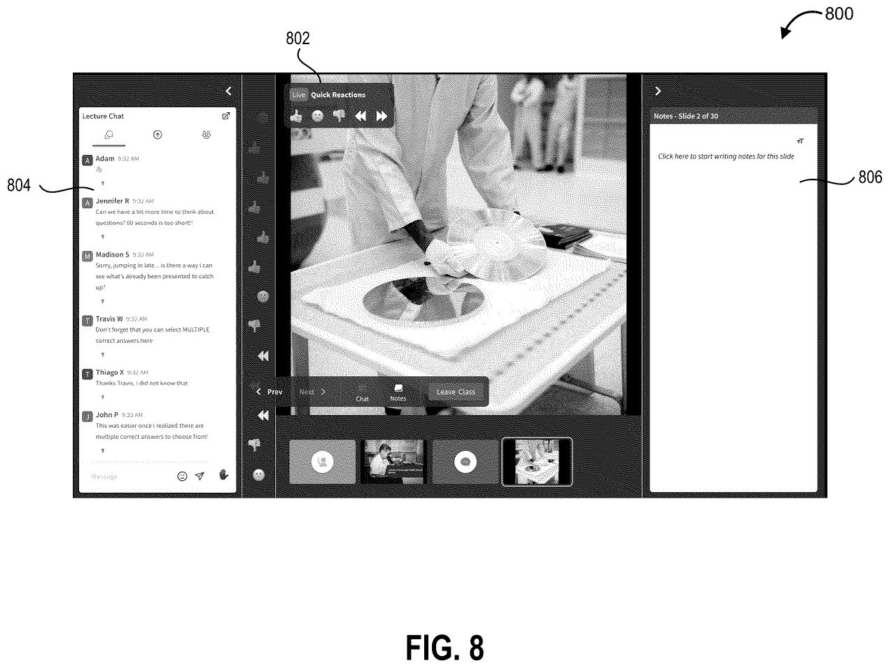

FIG. 8 illustrates an example learner view 800 with the notes 806 and chatbox 804 open while the lecture is being presented, according to some embodiments.

The learner view 800 shows the view when the chatbox 804 and learner notes 806 are opened. The main window 802 is still visible.

The chatbox 804 can be the same as is described above for the chatbox 504 in FIG. 5.

The learner notes 806 can provide a place where the learner can take notes prior during the lecture. These notes may be used as a form of unstructured feedback, for example, to assess the engagement by the students.

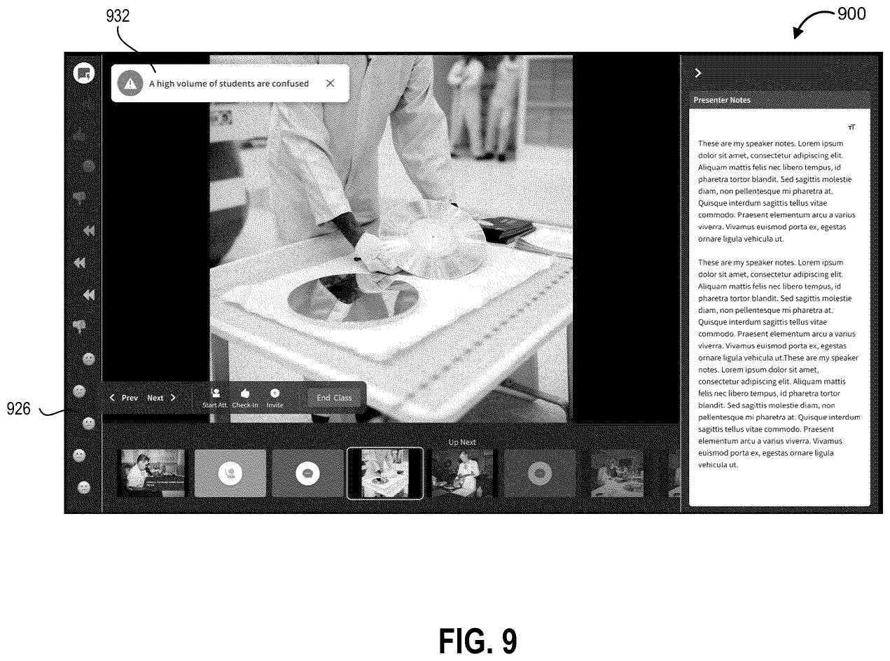

FIG. 9 illustrates an example lecturer view 900 displaying a notification 932 based on unstructured feedback, according to some embodiments.

During the lecture, the lecturer may also be able to view the reaction stream 926 being generated by learner reactions. The lecturer may be able to use this to qualitatively assess engagement and/or comprehension. The system may further be configured to analyze the reactions in the reaction stream 926 to ascertain more specific insights. Namely, the system may be configured to prompt the lecturer with a warning when a high volume of learners indicate confusion or ambivalence about the content. This may be done by taking the reaction in the reaction stream 926 or it may be done my using a learner's most recent reaction to assess engagement/comprehension (i.e., to limit the effect of a single student spamming a reaction). The prompts may be generated in a number of ways based on a number of engagement factors.

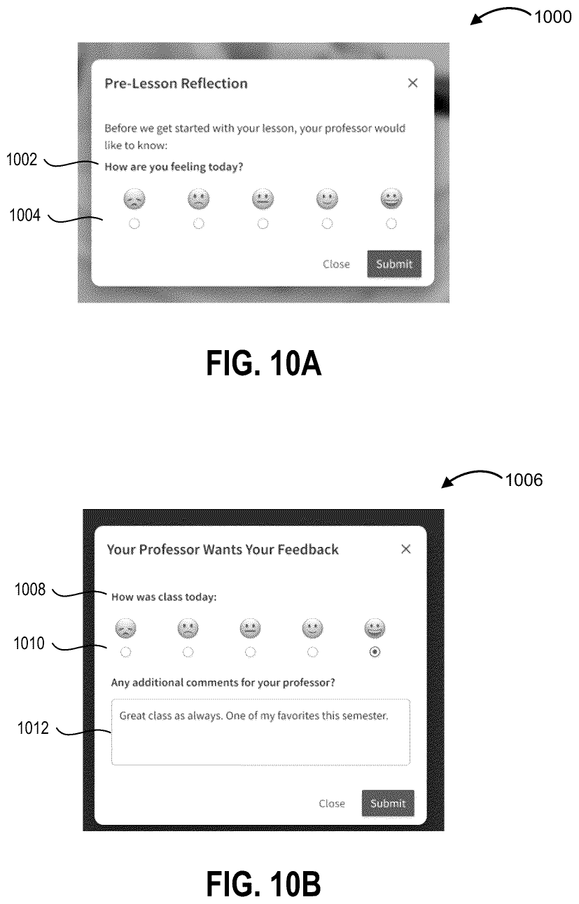

FIG. 10A illustrates an example pre-lesson reflection 1000 for learners, according to some embodiments.

The pre-lesson reflection 1000 can aid the lecturer in ascertaining general enthusiasm of the learners prior to the lecture. It can help the lecturer decide how to present the material or it can prompt the lecturer to ask more particularized questions of the learners. These reflections can be tracked with the learners so that general trends by specific learners can be identified and responded to.

The pre-lesson reflection 1000 may request structured feedback from the learners. It may pose a question 1002 and ask the learner to respond using the reactions 1004. The question can simply be general (e.g., “How are you feeling today?”) or it can be more specific (e.g., “How do you feel about the upcoming midterm?”). The reactions provided range from happy to sad, but other reactions are conceived.

FIG. 10B illustrates an example post-lesson reflection 1006 for learners, according to some embodiments.

The post-lesson reflection 1006 can aid the lecturer in ascertaining general enthusiasm of the learners after the lecture. It can help the lecturer decide how to present future material or it can prompt the lecturer to repeat some material in the next class. These reflections can be tracked with the learners so that general trends by specific learners can be identified and responded to. They can further be compared to the pre-lesson reflections 1000 to identify the effect each lecture had on the attitude of the learner.

The post-lesson reflection 1006 may request structured feedback from the learners. It may pose a question 1008 and ask the learner to respond using the responses 1010.

The post-lesson reflection 1006 can also include a comment box 1012 so that the learner can provide, for example, specific questions they were unable to ask of the lecturer before the end of class.

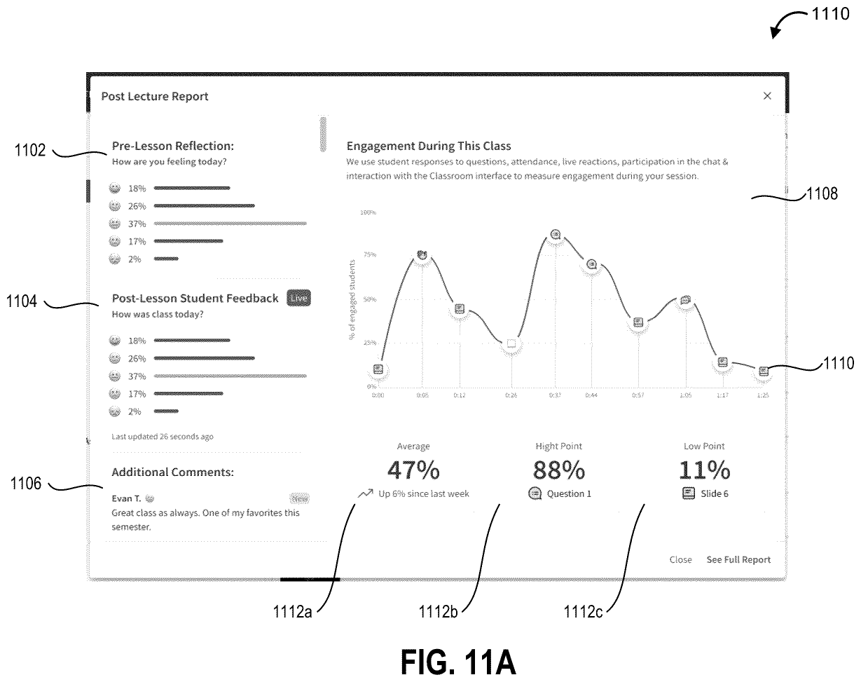

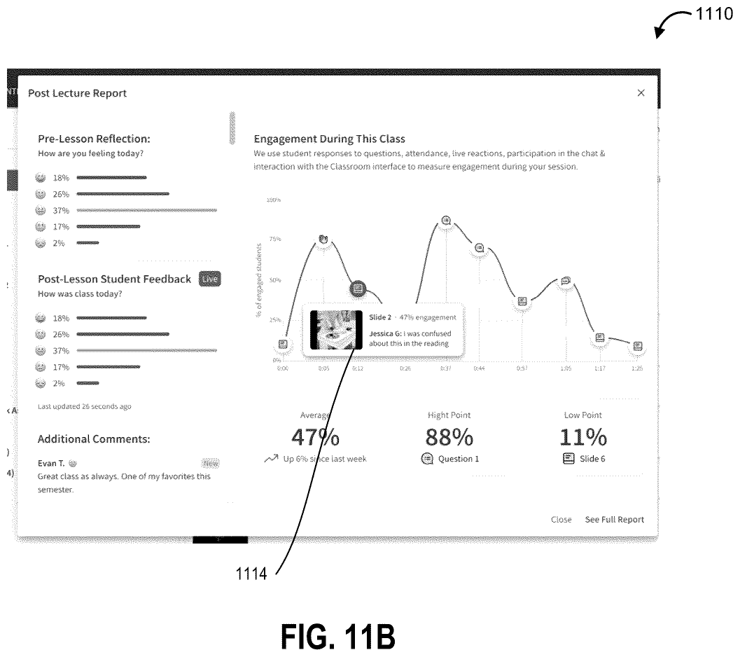

FIG. 11A illustrates an example post-lecture report 1100, according to some embodiments.

The post-lecture report 1100 can analyze the feedback (structured and unstructured) received during the lecture to develop insights into the lecture and for the learners. The post-lecture report 1100 can include for example, pre-lesson reflection results 1102, post-lesson reflection results 1104, additional comments 1106, engagement metrics graph 1108 with content segments 1110 indicated, and engagement statistics 1112 (inclusive of 1112a-1112c).

The pre-lesson reflection results 1102 can provide insight on the results of the pre-lesson reflections requested of the learners (e.g., pre-lesson reflection 1000 in FIG. 10A). The post-lesson reflection results 1104 can provide insight on the results of the post-lesson reflections requested of the learners (e.g., the post-lesson reflection 1006 in FIG. 10B). The additional comments 1106 can include additional comments provided as a part of either the pre-lesson or post-lesson reflection. The additional comment could also include a comment provided in the chatbox during the lecture which received a high level of engagement from other learners.

The engagement metrics graph 1108 can illustrate the engagement metrics of the learners over the course of the lecture. The content segments can be indicated with icons 1110. The engagement can be assessed using the structured and unstructured feedback received from the learners during or about those content segments. The report may additionally be able to show comprehension graphs as a form of engagement (for example, certain content segments may not evoke much engagement because they are straight-forward and so a measure of confusion rather than raw engagement may be more helpful for the lecturer to see).

The engagement metrics graph 1108 can aid a lecturer in achieving the engagement profile they intend for the content. Pedagogical outcomes may require achieving certain engagement profiles throughout the content. For example, it may be important for engagement to peak during content segments or time in the lecture where critical information is being imparted. It may also be important for learners to have periods of lower engagement between critical content segments to allow their minds to rest and digest the information. As such, lecturers may attempt to achieve certain engagement metrics graph shapes during their lectures. Further, the engagement metrics graphs 1108 can be shared between different lecturers such that some lecturers (e.g., novice lecturers) can attempt to model the engagement metrics graphs 1108 of other lecturers (e.g., effective lecturers).

In some embodiments, the lecturer may be able to define an engagement metrics profile they are attempting to achieve (e.g., handcrafted, from another lecturer, or recommended by an algorithmic or machine learning process) and the system may provide the lecturer with recommendations on how to achieve this engagement metrics profile. For example, in the post-lecture report, the system may make recommendations on the order of content segments or pace of instruction. Other recommendation types are conceived.

Engagement statistics 1112 can also be provided to the lecturer. Examples of engagement statistics can include the average engagement 1112a, the highest point of engagement 1112b, and the lowest point of engagement 1112c. The engagement statistics can also show how they compare to past lectures (e.g., average engagement) or indicated on which content segment they occurred (highest and lowest engagement). Other engagement metrics are also possible include learner specific engagement metrics.

FIG. 11B illustrates the example post-lecture report 1110 of FIG. 11A with content segment specific information 1114 displayed, according to some embodiments.

The post-lecture report 1100 shows additional content segment specific information 1114. As part of the post-lecture report 1100, the lecturer may be able to review content segment specific analytics such as the level of engagement during that content segment or comments provided during or about that content segment.

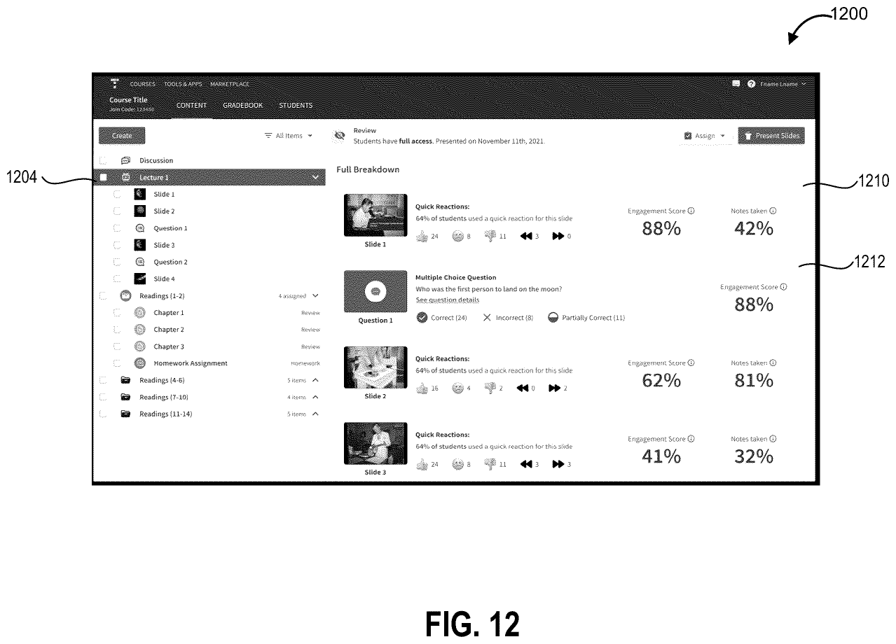

FIG. 12 illustrates an example lecturer view 1200 after a lecture, according to some embodiments. In addition to providing a post-lecture report. The post-lecture results may also be saved for future review with more granular information. For example, the lecturer may be able to review a content segment by content segment break-down of the feedback.

The lecturer view 1200 includes a lecture drop down 1204, a slide 1210, and a question 1212 (as well as all the other functionality described in FIG. 3).

The lecture drop down 1204 can allow the lecturer to open a previously presented lecture to review the engagement metrics included therewith.

The slide 1210 can enable the lecturer to see engagement statistic about the content segment. For example, slide 1210 illustrates the quick reactions used during the content segment, the engagement score, and the notes taken.

The question 1212 can enable the lecturer to see information about a structured feedback question posed during the presentation. The information illustrated indicates the number of learners who got the question right, partially right, or wrong, as well as an engagement score during the question.

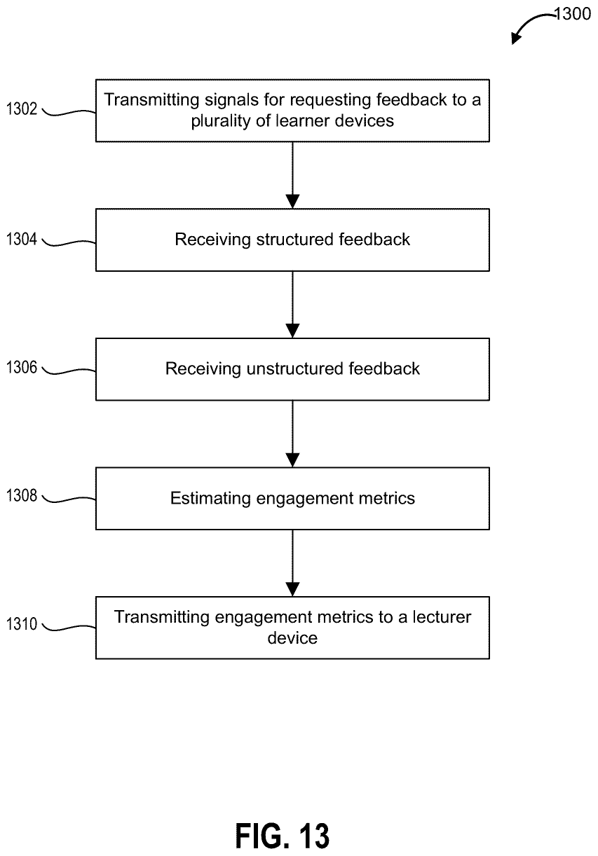

FIG. 13 illustrates a process diagram for a method 1300 of facilitating learning and engagement in a learning environment, according to some embodiments.

In accordance with an aspect, there is provided a computer-implemented method 1300 for conducting a lecture. The method 1300 including transmitting to a plurality of learner devices, each operated by a corresponding learner of a plurality of leaners, signals for providing a graphical user interface that presents one or more requests to the leaners to provide structured feedback at a corresponding plurality of first content locations predefined to be interspersed among a plurality of ordered content segments, each segment including a portion of learning content for the lecture and one or more requests to the learners to provide unstructured feedback at a plurality of second content locations that are not predefined (1302), receiving the structured feedback from at least one of the learners (1304), receiving the unstructured feedback from at least one of the learners (1306), upon analyzing the structured feedback and the unstructured feedback, estimating a plurality of engagement metrics each measuring a degree of engagement of the learners at a corresponding one of a plurality of time points during the lecture (1308), and transmitting to a lecturer device, data for generating a visual representation of the engagement metrics, the visual representation including a graph of the degree of engagement over the plurality of time points and visually mapped to the content segments (1310).

In accordance with a further aspect, the computer-implemented method 1300 further includes transmitting to the learner devices signals to cause a visual indicator of the unstructured feedback to be displayed by way of the graphical user interface, in response to receiving the unstructured feedback.

In accordance with a further aspect, the visual indicator is displayed in real-time during the lecture.

In accordance with a further aspect, an emoji selected from a plurality of emojis.

In accordance with a further aspect, the plurality of emojis including emojis corresponding to a plurality of sentiments expressible by the learners.

In accordance with a further aspect, the plurality of emojis include an emoji indicating a request to increase the pace of the lecture, and an emoji indicating a request to decrease the pace of the lecture.

In accordance with a further aspect, the request for structured feedback includes a question with multiple answers, each answer selectable by the learners.

In accordance with a further aspect, the method 1300 further includes receiving, in association with each of the unstructured feedback and the structured feedback, an identifier of the particular learner of the plurality of leaners providing the feedback.

In accordance with a further aspect, the method 1300 further includes upon processing the unstructured feedback and the structured feedback and the identifiers of the learners providing the feedback, generating an insight regarding a potential intervention for a particular learner of the plurality of leaners.

In accordance with a further aspect, the insight is generated by applying a machine learning model.

In accordance with a further aspect, the method 130 further comprising providing the potential intervention to the particular learner as an intervention, receiving feedback on the intervention from the particular learner, and updating the machine learning model based in part on the feedback from the particular learner.

In accordance with a further aspect, the insight includes data reflecting a profile of the given learner.

In accordance with a further aspect, the insight includes an identifier of recommended learning content suitable for the potential intervention.

In accordance with a further aspect, the method 1300 further includes transmitting to the plurality of learner devices signals for causing a chatbox to be presented by way of the graphical user interface, the chatbox allowing the learners to exchange electronic messages during the lecture.

In accordance with a further aspect, the estimating a plurality of engagement metrics 1308 includes processing the electronic messages.

In accordance with a further aspect, the method 1300 further includes receiving signals reflective of computer input activity of at least one of the learners.

In accordance with a further aspect, the estimating a plurality of engagement metrics 1308 includes processing the activity of the computer input the at least one of the learners.

In accordance with a further aspect, the degree of engagement includes a quality of engagement.

In accordance with a further aspect, the method 1300 further includes transmitting to at least one of the plurality of learner devices signals for providing a graphical user interface that presents the plurality of ordered content segments to a corresponding at least one learner.

In accordance with a further aspect, the method 1300 further includes transmitting to a presentation device signals for providing a graphical user interface that presents the plurality of ordered content segments to one or more of the learners of a plurality of leaners.

In accordance with a further aspect, the lecture includes at least one of a virtual lecture, an in-person lecture, and a hybrid lecture.

### Learner-Specific Details

In some embodiments, the feedback can be associated with a learner identifier. The system can be configured to analyze the feedback from specific learners (within a lecture and over time) to identify if those learners are struggling with specific content. The content segments can each be associated with topics and if the learner appears to struggle with the same topics over a lecture or over multiple lectures (i.e., their confusion is not resolved). Then the system may be configured to identify this learner and alert the lecturer that they may be struggling (for example in a post-lecture report).

In some embodiments, the system may be configured to identify the topics with which the learner is struggling and check a store of additional resources for additional content that may be of use to that specific learner. The lecturer may be able to review and provide these materials to the learner or these materials may be forwarded automatically. In some embodiments, the system will further determine whether the learner's confusion has been resolved and update the additional resource identifying algorithm to better serve future learners.

In some embodiments, the feedback received from the learners can include structured feedback provided in the lecture (e.g., accuracy of answers on multiple choice questions) and unstructured feedback (e.g., content segments in which the user reported being confused). The system may also be configured to review the notes taken by the learner to identify possible gaps (e.g., if they took far fewer notes on content segments they subsequently struggled on).

### Implementation Details

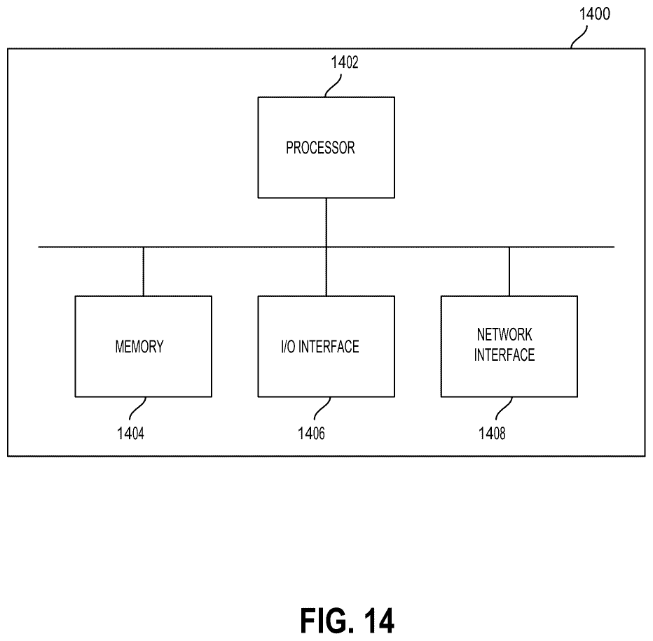

FIG. 14 is a schematic diagram of computing device 1400 which may be used to implement virtual lecture server 102, in accordance with an embodiment.

As depicted, computing device 1400 includes at least one processor 1402, memory 1404, at least one I/O interface 1406, and at least one network interface 1408.

Each processor 1402 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1404 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1406 enables computing device 1400 to interconnect with one or more input devices, such as a keyboard, mouse, camera, touch screen and a microphone, or with one or more output devices such as a display screen and a speaker.

Each network interface 1408 enables computing device 1400 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 1400 is shown but virtual lecture server 102 may include multiple computing devices 1400. The computing devices 1400 may be the same or different types of devices. The computing devices 1400 may be connected in various ways including directly coupled, indirectly coupled via a network, and distributed over a wide geographic area and connected via a network (which may be referred to as “cloud computing”).

For example, and without limitation, a computing device 1400 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which may be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented method for conducting a lecture, the method comprising:
transmitting to a plurality of learner devices, each operated by a corresponding learner of a plurality of leaners, signals for providing a graphical user interface that presents:
one or more requests to the leaners to provide structured feedback at a corresponding one or more of first content locations predefined to be interspersed among a plurality of ordered content segments, each segment including a portion of learning content for the lecture;
one or more requests to the learners to provide unstructured feedback at a plurality of second content locations that are not predefined;
receiving the structured feedback from at least one of the learners;
receiving the unstructured feedback from at least one of the learners;
upon analyzing the structured feedback and the unstructured feedback, estimating a plurality of engagement metrics each measuring a degree of engagement of the learners at a corresponding one of a plurality of time points during the lecture; and
transmitting to a lecturer device, data for generating a visual representation of the engagement metrics, the visual representation including a graph of the degree of engagement over the plurality of time points and visually mapped to the content segments.

2. The computer-implemented method of claim 1, further comprising:
in response to receiving the unstructured feedback, transmitting to the learner devices signals to cause a visual indicator of the unstructured feedback to be displayed by way of the graphical user interface.

3. The computer-implemented method of claim 2, wherein the visual indicator is displayed in real-time during the lecture.

4. The computer-implemented method of claim 1, wherein the unstructured feedback comprises an emoji selected from a plurality of emojis.

5. The computer-implemented method of claim 4, wherein the plurality of emojis include emojis corresponding to a plurality of sentiments expressible by the learners.

6. The computer-implemented method of claim 4, wherein the plurality of emojis include an emoji indicating a request to increase the pace of the lecture, and an emoji indicating a request to decrease the pace of the lecture.

7. The computer-implemented method of claim 1, wherein the request for structured feedback includes a question with multiple answers, each answer selectable by the learners.

8. The computer-implemented method of claim 1, further comprising:
receiving, in association with each of the unstructured feedback and the structured feedback, an identifier of the particular learner of the plurality of leaners providing the feedback.

9. The computer-implemented method of claim 8, further comprising:
upon processing the unstructured feedback and the structured feedback and the identifiers of the learners providing the feedback, generating an insight regarding a potential intervention for a particular learner of the plurality of leaners.

10. The computer-implemented method of claim 9, wherein the insight is generated by applying a machine learning model.

11. The computer-implemented method of claim 10, further comprising:
providing the potential intervention to the particular learner as an intervention;
receiving feedback on the intervention from the particular learner; and
updating the machine learning model based in part on the feedback from the particular learner.

12. The computer-implemented method of claim 9, wherein the insight includes data reflecting a profile of the given learner.

13. The computer-implemented method of claim 9, wherein the insight includes an identifier of recommended learning content suitable for the potential intervention.

14. The computer-implemented method of claim 1, further comprising:
transmitting to the plurality of learner devices signals for causing a chatbox to be presented by way of the graphical user interface, the chatbox allowing the learners to exchange electronic messages during the lecture.

15. The computer-implemented method of claim 14, wherein the estimating a plurality of engagement metrics includes processing the electronic messages.

16. The computer-implemented method of claim 1, further comprising:
receiving signals reflective of computer input activity of at least one of the learners.

17. The computer-implemented method of claim 14, wherein the estimating a plurality of engagement metrics includes processing the activity of the computer input the at least one of the learners.

18. The computer-implemented method of claim 1, wherein the degree of engagement includes a quality of engagement.

19. The computer-implemented method of claim 1, further comprising:
transmitting to at least one of the plurality of learner devices signals for providing a graphical user interface that presents the plurality of ordered content segments to a corresponding at least one learner.

20. The computer-implemented method of claim 1, further comprising:
transmitting to a presentation device signals for providing a graphical user interface that presents the plurality of ordered content segments to one or more of the learners of a plurality of leaners.

21. The computer-implemented method of claim 1, wherein the lecture comprises at least one of a virtual lecture, an in-person lecture, and a hybrid lecture.

22. A computer-implemented system for conducting a lecture, the system comprising:
at least one processor;
memory in communication with said at least one processor;
software code stored in said memory, which when executed at said at least one processor causes the system to:
transmit to a plurality of learner devices, each operated by a corresponding learner of a plurality of leaners, signals for providing a graphical user interface that presents:
one or more requests to the leaners to provide structured feedback at a corresponding one or more of first content locations predefined to be interspersed among a plurality of ordered content segments, each segment including a portion of learning content for the lecture;
one or more requests to the learners to provide unstructured feedback at a plurality of second content locations that are not predefined;
receive the structured feedback from at least one of the learners;
receive the unstructured feedback from at least one of the learners;
upon analyzing the structured feedback and the unstructured feedback, estimate a plurality of engagement metrics each measuring a degree of engagement of the learners at a corresponding one of a plurality of time points during the lecture; and
transmit to a lecture device, data for generating a visual representation of the engagement metrics, the visual representation including a graph of the degree of engagement over the plurality of time points and visually mapped to the content segments.
